(19) United States
(12) Patent Application Publication
(10) Pub. No.: US 2025/0377608 A1
(43) Pub. Date: Dec. 11, 2025

(54) EXPOSURE DEVICE AND IMAGE FORMING APPARATUS

(71) Applicant: SHARP KABUSHIKI KAISHA, Osaka (JP)

(72) Inventor: Yoshio MIZUYAMA, Osaka (JP)

(21) Appl. No.: 19/208,859

(22) Filed: May 15, 2025

(30) Foreign Application Priority Data
Jun. 11, 2024 (JP) 2024-094247

(51) Int. Cl. G03G 15/041; B41J 2/45; G03G 15/04

(52) U.S. Cl. CPC G03G 15/0415; B41J 2/45; G03G 15/04036

(57) ABSTRACT

An image forming apparatus includes a panel member opposing a photoreceptor and having plural light-emitting elements. The panel member has plural element groups, in which the light-emitting elements are arranged in a main scanning direction along a rotation axis of the photoreceptor. In the element group, the adjacent light-emitting elements in the main scanning direction are disposed such that positions in a sub-scanning direction orthogonal to the main scanning direction are shifted from one end side to the other end side toward one side in the main scanning direction. Density correction is performed to lower density of pixels when the pixels adjacent to each other in the main scanning direction and corresponding to the light-emitting element on one end side arranged at one end in the sub-scanning direction and the light-emitting element on the other end side arranged at the other end in the sub-scanning direction are exposed to light.

### INCORPORATION BY REFERENCE

This application claims the priority based on Japanese Patent Application No. 2024-094247 filed in Japan on Jun. 11, 2024, the entire contents of which are incorporated herein by reference in its entirety.

### BACKGROUND OF THE INVENTION

### Field of the Invention

The present disclosure relates to an exposure device including a panel member having plural light-emitting elements, and to an image forming apparatus.

### Description of the Background Art

Conventionally, electrophotographic image forming apparatuses, in which an electrostatic latent image is formed on a photoreceptor by using a laser light or the like, and then the electrostatic latent image is developed, transferred, and fixed to form an image on paper, have been widely used. In recent years, a linear light source, in which point light sources such as light-emitting elements are arranged in a line, is frequently used as a light source for exposing the photoreceptor. In addition, such a method has been proposed that the plural light-emitting elements are arranged not only in a main scanning direction but also in a sub-scanning direction to increase an exposure amount or increase pixel density.

The conventional image forming apparatus controls light emission of a light source device that includes plural light-emitting element arrays formed by arranging the plural light-emitting elements in the sub-scanning direction, thereby forms the electrostatic latent image, and includes: an image information acquirer that acquires image information of the electrostatic latent image; a light source controller that sequentially controls light emission of the plural light-emitting elements on the basis of the image information; an error information acquirer that acquires information on an error of a direction in which the light-emitting elements are arranged with respect to the sub-scanning direction; and an adjustment value generator that generates an adjustment value of a light emission amount of the light-emitting elements. In this image forming apparatus, the light emission amount of the light-emitting element with a small attachment error is increased to prevent worsening of image quality.

By the way, there is a case where it is difficult to arrange the light-emitting elements in a line or in a matrix due to high definition or low power consumption, and in such a case, the light-emitting elements may be shifted in a cyclic manner in the sub-scanning direction. Such arrangement causes a problem that density becomes higher than expected due to a phenomenon called reciprocity failure when the light-emitting elements that are significantly distant from each other in the sub-scanning direction expose adjacent pixels.

The present disclosure has been made to solve the problem described above, and an object thereof is to provide an exposure device and an image forming apparatus capable of maintaining appropriate image quality.

### SUMMARY OF THE INVENTION

In an exposure device including a panel member that opposes a photoreceptor and has plural light-emitting elements, the panel member has plural element groups, in each of which the plural light-emitting elements are arranged in a main scanning direction along a rotation axis of the photoreceptor, and in the element group, the light-emitting elements that are adjacent to each other in the main scanning direction are disposed such that positions thereof in a sub-scanning direction, which is orthogonal to the main scanning direction, are shifted from one end side to the other end side toward one side in the main scanning direction. The exposure device includes one or more controllers, and the one or more controllers perform density correction to lower density of pixels when the pixels, which are adjacent to each other in the main scanning direction and correspond to the light-emitting element on one end side arranged at one end in the sub-scanning direction and the light-emitting element on the other end side arranged at the other end in the sub-scanning direction, are exposed to light.

The exposure device according to the present disclosure may lower the light intensity of the corresponding light-emitting element in the density correction.

The exposure device according to the present disclosure may alternately lower light intensity of the light-emitting element on the one end side and light intensity of the light-emitting element on the other end side along the sub-scanning direction when the pixels that continue in the sub-scanning direction are exposed to the light in the density correction.

In the exposure device according to the present disclosure, in the density correction, when the pixels that continue in the sub-scanning direction are exposed to the light, the pixels, the density of which is to be lowered, may be arranged separately in the sub-scanning direction.

In the exposure device according to the present disclosure, in the density correction, light intensity of the light-emitting element on the one end side and light intensity of the light-emitting element on the other end side may be corrected on the basis of light intensity of the light-emitting element that is adjacent to the light-emitting element on the one end side and the light-emitting element on the other end side in the main scanning direction.

An image forming apparatus according to the present disclosure includes the exposure device according to the present disclosure.

According to the present disclosure, when there is a significant exposure time difference between the adjacent pixels, the density of the pixel is increased by a phenomenon of reciprocity failure. Accordingly, by correcting this, appropriate image quality can be maintained.

### BRIEF DESCRIPTION OF THE DRAWINGS

FIG. 1 is a schematic cross-sectional view illustrating an image forming apparatus according to a first embodiment of the present disclosure.

FIG. 2 is a schematic configuration diagram illustrating the image forming apparatus according to the first embodiment of the present disclosure.

FIG. 3 is a schematic plan view illustrating a panel member in the first embodiment of the present disclosure.

FIG. 4 is a characteristic graph illustrating a relationship between an exposure time difference and density.

FIG. 5 is a characteristic table illustrating an example of image data before and after density correction.

FIG. 6 is a characteristic table illustrating an example of the image data before and after the density correction in a second embodiment of the present disclosure.

FIG. 7 is a characteristic table illustrating an example of the image data before and after the density correction in a third embodiment of the present disclosure.

FIG. 8 is a characteristic table illustrating an example of the image data before and after the density correction in a fourth embodiment of the present disclosure.

### DESCRIPTION OF THE PREFERRED EMBODIMENTS

### First Embodiment

Hereinafter, a description will be made on an image forming apparatus according to a first embodiment of the present disclosure with reference to the drawings.

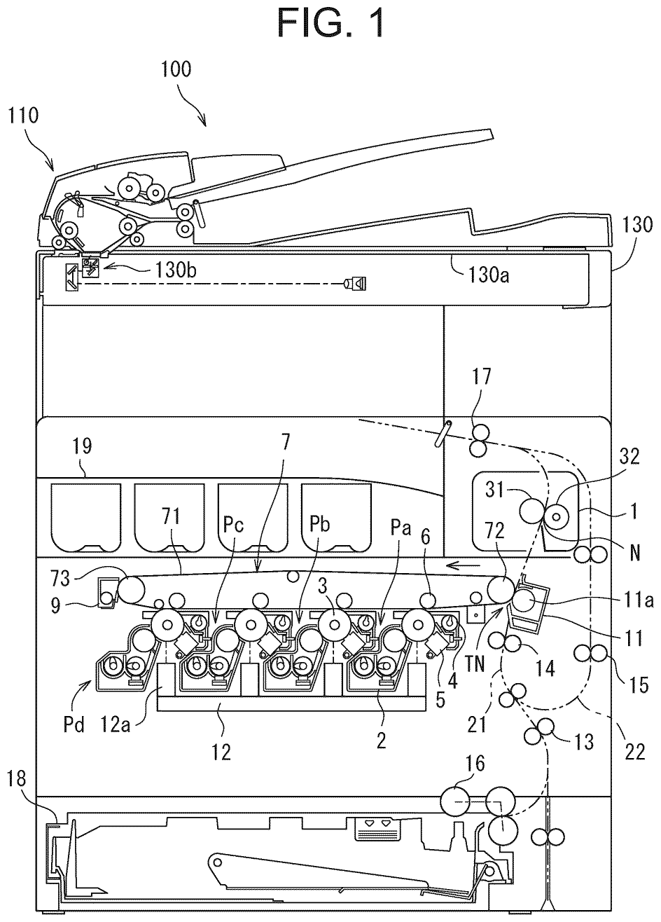

FIG. 1 is a schematic cross-sectional view illustrating the image forming apparatus according to the first embodiment of the present disclosure.

An image forming apparatus 100 is a multifunction peripheral that has a copier function, a scanner function, a facsimile function, and a printer function, sends an image of a document read by an image reader 130 to the outside, and forms the image of the document read by the image reader 130 or an image received from the outside on a recording medium such as a sheet of paper in color or in a single color.

A document conveyor 110 that is supported in a freely openable/closable manner is provided above the image reader 130. The document conveyor 110 sequentially conveys one or more sheets of the document one at a time. The image reader 130 scans and reads the document, which has been placed on a document placement table 130a, with a scanning optical system 130b or reads the document conveyed by the document conveyor 110 to generate image data.

The image forming apparatus 100 includes a fixing device 1, a developing device 2, a photoreceptor drum 3 (an example of a photoreceptor), a drum cleaner 4, a charger 5, an intermediate transfer belt device 7, a secondary transfer device 11, an exposure device 12, a paper feeder 18, and the like.

In the image forming apparatus 100, the image data corresponding to a color image using each color of black (K), cyan (C), magenta (M), and yellow (Y), or a monochrome image using a single color (for example, black). In the image forming apparatus 100, four each of the developing devices 2, the photoreceptor drums 3, the drum cleaners 4, and the chargers 5 are provided to form four types of toner images, each set thereof corresponds to respective one of black, cyan, magenta, and yellow, and four image stations Pa, Pb, Pc, Pd are thereby formed.

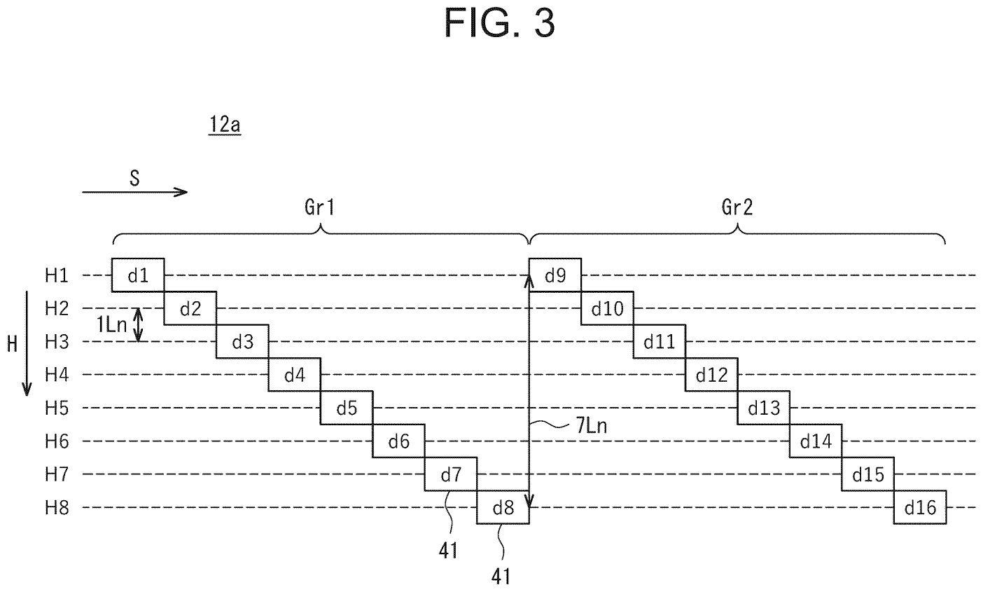

The charger 5 uniformly charges a surface of the respective photoreceptor drum 3 to a predetermined potential. The exposure device 12 has a panel member 12a that opposes the surface of the respective photoreceptor drum 3, and exposes the surface of the respective photoreceptor drum 3 to form an electrostatic latent image. The developing device 2 develops the electrostatic latent image on the surface of the respective photoreceptor drum 3 and forms the toner image on the surface of the respective photoreceptor drum 3. The drum cleaner 4 removes and collects residual toner from the surface of the respective photoreceptor drum 3. Through a series of above-described operations, the toner image in each color is formed on the surface of the respective photoreceptor drum 3. The panel members 12a will be described in detail with reference to FIG. 3.

The intermediate transfer belt device 7 includes an intermediate transfer roller 6, an endless intermediate transfer belt 71, an intermediate transfer drive roller 72, an intermediate transfer driven roller 73, and a cleaner 9. The four intermediate transfer rollers 6 are provided on an inner side of the intermediate transfer belt 71, so as to form four types of the toner images corresponding to the respective colors. The intermediate transfer rollers 6 each transfer the toner image in the respective color, which has been formed on the surface of the respective photoreceptor drum 3, onto the intermediate transfer belt 71 that circles.

The intermediate transfer belt 71 is stretched over the intermediate transfer drive roller 72 and the intermediate transfer driven roller 73. In the image forming apparatus 100, the toner images in the respective colors, which have been formed on the surfaces of the photoreceptor drums 3, are sequentially transferred and superimposed on each other to form the colored toner image on the surface of the intermediate transfer belt 71. The cleaner 9 removes and collects waste toner that is not transferred to a sheet and remains on the surface of the intermediate transfer belt 71.

The secondary transfer device 11 nips the sheet, which has been conveyed through a paper conveyance path 21, in a transfer nipper TN between secondary transfer rollers 11a and the intermediate transfer belt 71 to convey the sheet. When the sheet passes through the transfer nipper TN, the toner image on the surface of the intermediate transfer belt 71 is transferred and conveyed to the fixing device 1.

The fixing device 1 includes a fixing belt 31 and a pressure roller 32 that rotate about respective axes. The fixing device 1 nips the sheet, to which the toner image has been transferred, in a nipper N between the fixing belt 31 and the pressure roller 32, heats and pressurizes the sheet, and fixes the toner image to the sheet. Although not illustrated in FIG. 1, the fixing device 1 may have components other than the fixing belt 31 and the pressure roller 32.

The paper feeder 18 includes a paper feed cassette that loads the recording medium (the sheet) used for image formation, and is provided below the exposure device 12. The paper is pulled from the paper feeder 18 by a pickup roller 16 and transported to the paper conveyance path 21. The sheet, which has been conveyed to the paper conveyance path 21, passes through the secondary transfer device 11 and the fixing device 1, and is ejected into a paper ejection tray 19 by ejection rollers 17.

In the paper conveyance path 21, conveyance rollers 13, resist rollers 14, and the ejection rollers 17 are disposed. The conveyance rollers 13 facilitate conveyance of the sheet. The resist rollers 14 convey the sheet at the same speed as a process speed at which the image is formed on the sheet. These resist rollers 14 are provided between the paper feeder 18 and the secondary transfer device 11, and adjust paper conveyance timing such that the toner image is transferred to the sheet by the secondary transfer device 11. For example, the resist rollers 14 stand by (stop for a moment) while clamping the sheet conveyed from the paper feeder 18, and then starts conveying the sheet at a constant speed in synchronization with the secondary transfer device 11.

In a case where the image is formed not only a front side but also on a back side of the sheet, the ejection rollers 17 change a conveyance direction of the sheet, and the sheet is then conveyed to a reverse conveyance path 22. In the reverse conveyance path 22, reverse conveyance rollers 15 guide and convey the sheet, whose front and back sides are reversed, to the resist rollers 14. The image forming apparatus 100 forms the image on the back side of the sheet, which has been guided to the resist rollers 14, in the same manner as on the front side, and ejects the sheet into the paper ejection tray 19.

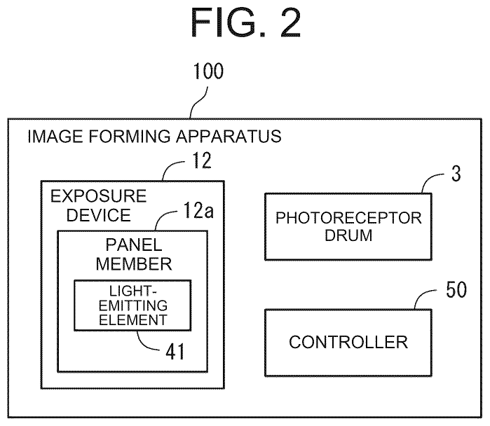

FIG. 2 is a schematic configuration diagram illustrating the image forming apparatus according to the first embodiment of the present disclosure. In FIG. 2, the image forming apparatus 100 is partially illustrated, and may appropriately include other members not illustrated in FIG. 2.

The panel member 12a includes plural light-emitting elements 41. The light-emitting element 41 is an organic electroluminescent (EL) diode (OLED) or a light-emitting diode (LED), for example. A controller 50 is a central processing unit (CPU) that is mounted on the image forming apparatus 100, controls operation of the image forming apparatus 100, and causes the image forming apparatus 100 to perform density correction described below, for example. Here, the controller 50 may include one or plural control circuits.

FIG. 3 is a schematic plan view illustrating the panel member in the first embodiment of the present disclosure.

In the exposure device 12, the four panel members 12a are provided in a manner to respectively oppose the four photoreceptor drums 3. The exposure device 12 may independently be provided for each of the photoreceptor drums 3, or the panel member 12a may be provided in a manner to correspond to each of the four photoreceptor drum 3. Since the four panel members 12a have substantially the same configuration, FIG. 3 schematically illustrates only one of the panel members 12a.

In the image forming apparatus 100, an axial direction along a rotation axis of the photoreceptor drum 3 is parallel to a width direction of the sheet on which the image is formed, and the photoreceptor drum 3 is configured to rotate about the rotation axis. The panel member 12a is a rectangular flat plate, a vertical direction (a main scanning direction S) thereof corresponds to the axial direction, and a short direction (a sub-scanning direction H) thereof corresponds to a rotational direction of the photoreceptor drum 3.

The panel member 12a includes element groups (a first element group Gr1 and a second element group Gr2), in each of which the plural light-emitting elements 41 are arranged in the main scanning direction S. FIG. 3 illustrates, as the panel member 12a, a configuration having the first element group Gr1 and the second element group Gr2, each of which includes the eight light-emitting elements 41. However, the panel member 12a is not limited thereto, and the number of the light-emitting elements 41 that constitute the element group or the number of the element groups provided in the panel member 12a may appropriately be changed. Hereinafter, in order to distinguish the plural light-emitting elements 41 from each other, the light-emitting elements 41 may be denoted by reference signs d1, d2, . . . , d16 in an order from one end side (a left end side in FIG. 3) to the other end side (a right end side in FIG. 3) in the main scanning direction S. That is, the first element group Gr1 includes the light-emitting elements 41 of d1 to d8, and the second element group Gr2 includes the light-emitting elements 41 of d9 to d16.

In the element group, the light-emitting elements 41 that are adjacent to each other in the main scanning direction S are disposed such that positions thereof in the sub-scanning direction H are shifted from one end side (an upper end side in FIG. 3) to the other end side (a lower end side in FIG. 3) toward one side in the main scanning direction S. Broken lines (a first line to an eighth line) H1 to H8 illustrated in FIG. 3 are parallel in the main scanning direction S, are arranged at constant intervals in the sub-scanning direction H, and indicate positions of the light-emitting elements 41 in the sub-scanning direction H. That is, it is indicated that the positions of the light-emitting elements 41 that are arranged on the same line overlap in the sub-scanning direction H.

In the panel member 12a illustrated in FIG. 3, the light-emitting element 41 of d1 is arranged on the first line (H1) located on the uppermost end side in FIG. 3, and the light-emitting element 41 of d2 is arranged on the second line (H2) that is shifted to the lower end side from the first line. Similarly, the light-emitting elements 41 of d3 onward are arranged to be sequentially shifted to the lower end side, and the light-emitting element 41 of d8 is arranged on the eighth line (H8) positioned on the lowermost end side in FIG. 3.

In the second element group Gr2, the same arrangement as that in the first element group Gr1 is repeated, and the light-emitting element 41 of d9 is arranged on the first line (H1). The light-emitting elements 41 of d10 onward are arranged to be sequentially shifted to the lower end side, and the light-emitting element 41 of d16 is arranged on the eighth line (H8).

As described above, in the same element group, a distance between the adjacent light-emitting elements 41, such as the light-emitting element 41 of d2 and the light-emitting element 41 of d3, in the sub-scanning direction H is a distance corresponding to one line (a one-line difference 1Ln). Meanwhile, on a boundary between the element groups, the distance between the adjacent light-emitting elements 41, such as the light-emitting element 41 of d8 and the light-emitting element 41 of d9, in the sub-scanning direction H is a distance corresponding to seven lines (a seven-line difference 7Ln).

In the exposure device 12, the light-emitting elements 41 are exposed to light in an order from an upstream side in the rotational direction of the photoreceptor drum 3, and exposure timing of the light-emitting elements 41 is controlled in accordance with the rotation of the photoreceptor drum 3. More specifically, in the configuration illustrated in FIG. 3, the light-emitting elements 41 on the first line (H1), that is, the light-emitting element 41 of d1 and the light-emitting element of d9 are located on the most upstream side in the rotational direction of the photoreceptor drum 3 and are exposed to the light first. Meanwhile, the light-emitting elements 41 on the eighth line (H8), that is, the light-emitting element 41 of d8 and the light-emitting element 41 of d16 are located on the most downstream side in the rotational direction of the photoreceptor drum 3 and are exposed to the light lastly.

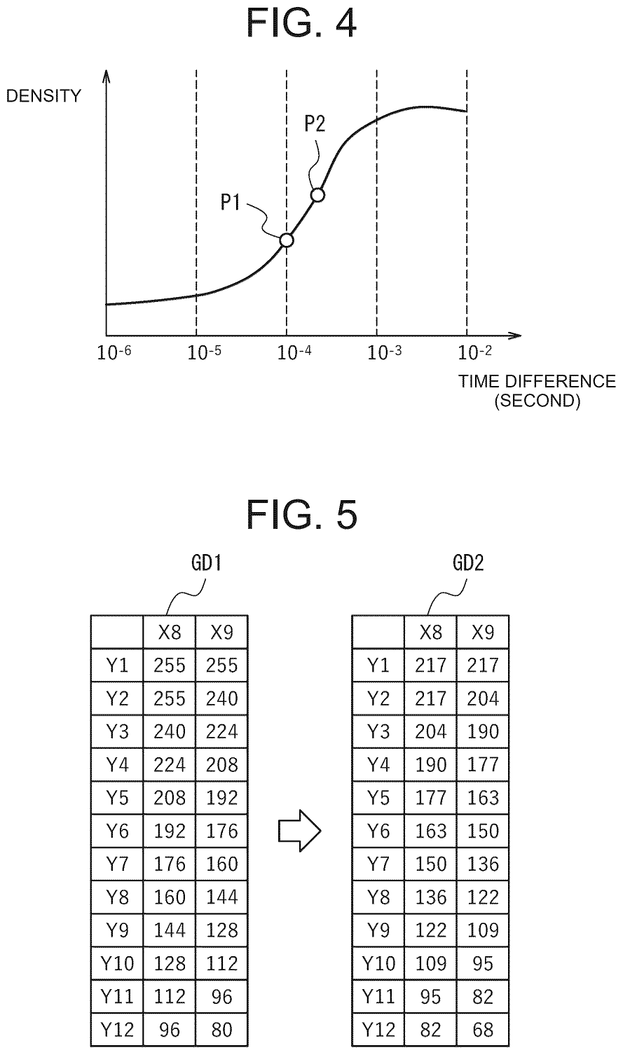

Here, when attention is paid to the light-emitting element 41 of d9 (corresponding to the light-emitting element on one end side), which is arranged at one end in the sub-scanning direction H, the light-emitting element 41 of d8 (corresponding to the light-emitting element on the other end side), which is arranged at the other end in the sub-scanning direction H, both thereof are arranged to be adjacent in the main scanning direction S. But, in the sub-scanning direction H, these light-emitting elements 41 are separated farthest from each other, and there is a significant time difference in the exposure timing. Since the significant increase in the difference of the exposure timing (exposure time difference) between adjacent pixels affects the density, a description thereon will be made with reference to FIG. 4.

FIG. 4 is a characteristic graph illustrating a relationship between the exposure time difference and the density.

In FIG. 4, a horizontal axis represents the exposure time difference between the adjacent pixels, and a vertical axis represents the density of the pixels. As described above, when there is the significant exposure time difference between the adjacent pixels, the density of the pixel may become high due to a phenomenon of reciprocity failure. In FIG. 4, a point P1 corresponds to the exposure time difference of the one-line difference 1Ln, a point P2 corresponds to the exposure time difference of the seven-line difference 7Ln, and the density of the point P2 is higher than that of the point P1. Even when an exposure amount and the like are set to obtain the same density, just as described, the intended density may not be obtained depending on the arrangement of the light-emitting elements 41.

To handle such a problem, in the present embodiment, the density correction for correcting the density of the pixel is performed according to the arrangement of the light-emitting elements 41, and the density is thereby adjusted to be appropriate. Next, a description will be made on the density correction with reference to FIG. 5.

FIG. 5 is a characteristic table illustrating an example of the image data before and after the density correction.

In the image forming apparatus 100, vertical and horizontal coordinates are set for each pixel of the image data for forming the image. A horizontal direction X is the width direction of the sheet and corresponds to the axial direction of the photoreceptor drum 3 (the main scanning direction S). A vertical direction Y is a longitudinal direction of the sheet and corresponds to the rotational direction of the photoreceptor drum 3 (the sub-scanning direction H). Hereinafter, for the description, the coordinate in the horizontal direction X may be abbreviated as Xn (n is a natural number), and the coordinate in the vertical direction Y may be abbreviated as Ym (m is a natural number).

In FIG. 5, the image data is partially illustrated, X8 is a coordinate that corresponds to the light-emitting element 41 of d8, X9 is a coordinate that corresponds to the light-emitting element 41 of d9, and a value at each coordinate indicates the density of the corresponding pixel. Gradations having plural stages is set for the density, and the 256 stages (gradations) are set in the example illustrated in FIG. 5. The gradation is set such that the density is increased with an increase in the value and is lowered with a reduction in the value. The pixel having the density of 0 corresponds to a portion that is not colored with the toner, and corresponds to the pixel that is not exposed to the light by the light-emitting element 41. However, the gradation is not limited thereto. The density may be converted in a manner to reduce the stages, such as 16 stages or 4 stages, and capacity of the image data may thereby be reduced.

FIG. 5 is a characteristic table illustrating first image data GD1 before the density correction and second image data GD2 after the density correction. In the density correction, based on a correction coefficient that is set in advance, the density is corrected for a combination of the pixels having the same coordinate in the vertical direction Y and corresponding to X8 and X9. As a result, the density at each coordinate in the second image data GD2 becomes lower than that in the first image data GD1. In the exposure device 12, light intensity of each of the light-emitting elements 41 is determined on the basis of the density in the second image data GD2. Just as described, when there is the significant exposure time difference between the adjacent pixels, the density of the pixel is increased by the phenomenon of the reciprocity failure. Accordingly, by correcting this, the appropriate image quality can be maintained. In addition, the density can easily be corrected by lowering the light intensity of the light-emitting element 41.

The correction coefficient may be set appropriately. For example, the correction coefficient may be set such that a correction amount of the density is reduced as the density of either one of X8 and X9 approaches 0, or may be set such that the correction amount becomes 0 when either one thereof is 0. In other words, an influence of the exposure amount on the increase in the density caused by the reciprocity failure becomes significant as the exposure amount is increased. When only one of the light-emitting elements 41 is exposed to the light, the density is not affected by the reciprocity failure. Thus, the appropriate correction coefficient is preferably set to make a correction based on this.

### Second Embodiment

Next, a description will be made on an image forming apparatus according to a second embodiment of the present disclosure with reference to the drawings. In the second embodiment, the contents of the density correction differ from those in the first embodiment. In the second embodiment, substantially the same configuration as that in the first embodiment illustrated in FIGS. 1 to 5 is provided. Thus, the description thereon will not be made and will be made only on differences.

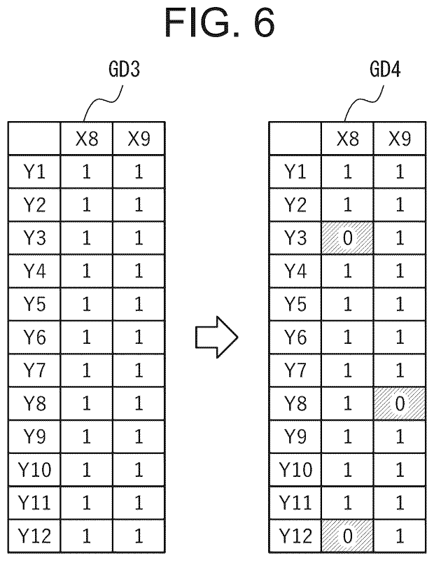

FIG. 6 is a characteristic table illustrating an example of the image data before and after the density correction in the second embodiment of the present disclosure.

FIG. 6 illustrates third image data GD3 before the density correction and fourth image data GD4 after the density correction. In the example illustrated in FIG. 6, the density has two gradations, the light-emitting elements 41 expose the pixels corresponding to 1, but the light-emitting elements 41 do not expose the pixels corresponding to 0. That is, when the density has the two gradations, whether the light-emitting element 41 emits the light or does not emit the light (non-light emission) is controlled.

In the third image data GD3, all the pixels corresponding to X8 and X9 have the density of 1. That is, when only X8 and X9 are focused, the image is a straight line that has two pixels in width and extends in the vertical direction Y.

In the density correction, when the pixels that continue in the sub-scanning direction H (the vertical direction Y) are exposed to the light, the light intensity of the light-emitting element on one end side (for example, the light-emitting element 41 of d9) and the light intensity of the light-emitting element on the other end side (the light-emitting element 41 of d8) are alternately lowered along the sub-scanning direction H, and the pixels, the density of which is lowered, are arranged separately in the sub-scanning direction H. More specifically, the fourth image data GD4 differs from the third image data GD3 in that the density of the pixel as X8 and Y3, the density of the pixel as X9 and Y8, and the density of the pixel as X8 and Y12 are set to 0. In FIG. 6, in the fourth image data GD4, the pixels, the density of which has been changed by the density correction, in the third image data GD3 are hatched.

In the density correction, the density is accumulated in an order from the top in the vertical direction Y, and when the accumulated value exceeds a threshold value, the density of X8 is lowered. Thereafter, the accumulated value is reset, and the density is accumulated again. Then, when the accumulated value exceeds the threshold value next time, the density of X9 is lowered instead of X8, the density of which has been lowered last time. That is, the pixels, the density of which is to be lowered, are alternately changed between X8 and X9. By sequentially repeating this processing, the pixels, the density of which has been lowered, can be dispersed so as not to be concentrated locally. In this way, the correction can be made to prevent occurrence of a portion in which the density is extremely lowered by dispersing the pixels, the density of which is to be lowered, when the exposed range is wide.

As described above, when the light-emitting elements 41 are controlled only by the light emission and the non-light emission without changing the light intensity, the density of the image may be corrected to be lowered by thinning such that the pixels, to which the light is not emitted, are dispersed.

### Third Embodiment

Next, a description will be made on an image forming apparatus according to a third embodiment of the present disclosure with reference to the drawings. In the third embodiment, the contents of the density correction differ from those in the second embodiment. In the third embodiment, substantially the same configuration as those in the first embodiment and the second embodiment illustrated in FIGS. 1 to 6 is provided. Thus, the description thereon will not be made, and the description will be made only on differences.

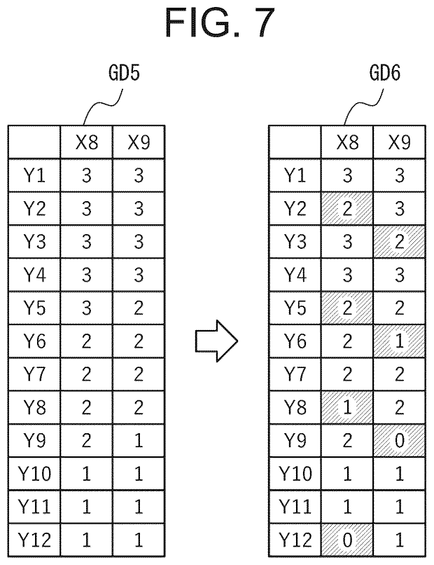

FIG. 7 is a characteristic table illustrating an example of the image data before and after the density correction in the third embodiment of the present disclosure.

FIG. 7 illustrates fifth image data GD5 before the density correction and sixth image data GD6 after the density correction. In the example illustrated in FIG. 7, the density has four gradations, the light-emitting elements 41 expose the pixels corresponding to 1 to 3, but the light-emitting elements 41 do not expose the pixels corresponding to 0. In FIG. 7, in the sixth image data GD6, the pixels, the density of which has been changed by the density correction, in the fifth image data GD5 are hatched.

Similar to the second embodiment, in the density correction, the pixels, the density of which is to be lowered, are alternately arranged between X8 and X9. The gradation of the pixels, the density of which is to be lowered, is lowered by one stage. When the gradation is 1, the gradation is set to 0, and the light-emitting element 41 does not emit the light.

### Fourth Embodiment

Next, a description will be made on an image forming apparatus according to a fourth embodiment of the present disclosure with reference to the drawings.

In the fourth embodiment, the contents of the density correction differ from those in the second embodiment. In the fourth embodiment, substantially the same configuration as those in the first embodiment to the third embodiment illustrated in FIGS. 1 to 7 is provided. Thus, the description thereon will not be made, and the description will be made only on differences.

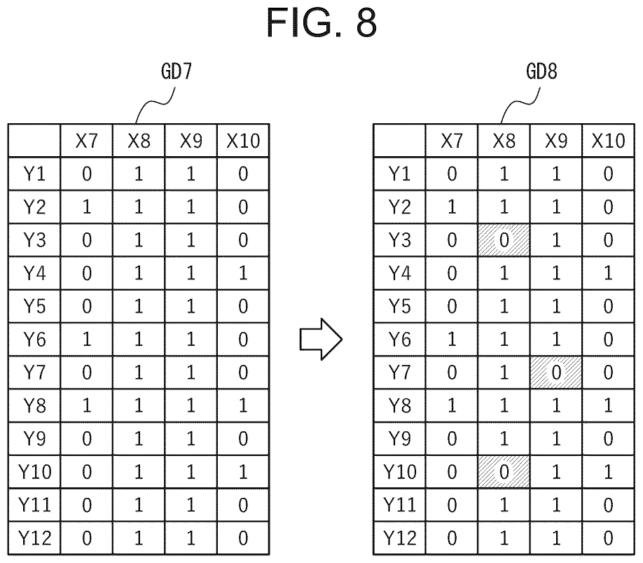

FIG. 8 is a characteristic table illustrating an example of the image data before and after the density correction in the fourth embodiment of the present disclosure.

FIG. 8 illustrates seventh image data GD7 before the density correction and eighth image data GD8 after the density correction.

The seventh image data GD7 and the eighth image data GD8 illustrated in FIG. 8 include not only the density corresponding to X8 and X9 but also the density at X7 as a coordinate corresponding to the light-emitting element 41 of d7 and the density at X10 as a coordinate corresponding to the light-emitting element 41 of d10.

In the density correction, the light intensity of the light-emitting elements 41 of d7 and the light-emitting elements 41 of d10, which are respectively adjacent to the light-emitting elements 41 of d8 and the light-emitting elements 41 of d9 in the main scanning direction, are also referred. More specifically, the density is accumulated in the order from the top in the vertical direction Y including all of X7 to X10, and it is determined whether the density exceeds the threshold value. Here, the pixels, the density of which is to be lowered, are alternately arranged between X8 and X9. In this way, the image quality can be adjusted further accurately by considering the influence of not only the adjacent pixel but also the pixel adjacent to the adjacent pixel.

The embodiments disclosed herein are illustrative in all respects and are not intended to be the basis for the limited interpretation. Accordingly, the technical scope of the present disclosure is not interpreted only by the embodiments described above, but is defined on the basis of the claims. The technical scope of the present disclosure includes all variations that are equivalent in meaning and scope to the claims.

What is claimed is:

1. An exposure device including: a panel member that opposes a photoreceptor and has plural light-emitting elements, in which
the panel member has plural element groups, in each of which the plural light-emitting elements are arranged in a main scanning direction along a rotation axis of the photoreceptor, and
in the element group, the light-emitting elements that are adjacent to each other in the main scanning direction are disposed such that positions thereof in a sub-scanning direction, which is orthogonal to the main scanning direction, are shifted from one end side to an other end side toward one side in the main scanning direction, the exposure device comprising:
one or more controllers, the one or more controllers performing density correction to lower density of pixels when the pixels, which are adjacent to each other in the main scanning direction and correspond to the light-emitting element on one end side arranged at one end in the sub-scanning direction and the light-emitting element on the other end side arranged at the other end in the sub-scanning direction, are exposed to light.

2. The exposure device according to claim 1, wherein
in the density correction, light intensity of the corresponding light-emitting element is lowered.

3. The exposure device according to claim 1, wherein
in the density correction, when the pixels that continue in the sub-scanning direction are exposed to the light, light intensity of the light-emitting element on the one end side and light intensity of the light-emitting element on the other end side are alternately lowered along the sub-scanning direction.

4. The exposure device according to claim 1, wherein
in the density correction, when the pixels that continue in the sub-scanning direction are exposed to the light, the pixels, the density of which is to be lowered, are arranged separately in the sub-scanning direction.

5. The exposure device according to claim 1, wherein
in the density correction, light intensity of the light-emitting element on the one end side and light intensity of the light-emitting element on the other end side are corrected on the basis of light intensity of the light-emitting element that is adjacent to the light-emitting element on the one end side and the light-emitting element on the other end side in the main scanning direction.

6. An image forming apparatus comprising:
the exposure device according to claim 1.
